(19) United States
(12) Patent Application Publication
(10) Pub. No.: US 2008/0102276 A1
(43) Pub. Date: May 1, 2008

(54) Controlled Release of a Curing Agent for the Generation of Microstructures

(76) Inventors: Ali Khademhosseini, Cambridge, MA (US); Giovanni Talei Franzesi, Cambridge, MA (US); Bin Ni, Columbus, OH (US); Yibo Ling, Canton, MI (US)

Correspondence Address: FISH & RICHARDSON PC, P.O. BOX 1022, MINNEAPOLIS, MN, 55440-1022, US

(21) Appl. No.: 11/925,199

(22) Filed: Oct. 26, 2007

Related U.S. Application Data
(60) Provisional application No. 60/855,061, filed on Oct. 27, 2006.

(51) Int. Cl. B29C 41/20; B29C 41/22; B32B 7/00

(52) U.S. Cl. 428/403; 264/239; 264/241; 264/255; 264/294; 264/299; 264/4

(57) ABSTRACT

A controlled release fabrication process includes shaping a precursor material into a desired configuration with a mold, supplying a curing agent from the mold to the precursor material, curing the precursor material to form a mechanically stable structure, and releasing the mechanically stable structure from the mold. Mechanically stable structures including microfabrication articles produced using the process are also described.

### CLAIM OF PRIORITY

This application claims priority under 35 USC § 119(e) to U.S. Patent Application Ser. No. 60/855,061, filed on Oct. 27, 2006, the entire contents of which are hereby incorporated by reference.

### TECHNICAL FIELD

This invention relates to microfabricated articles including microstructures.

### BACKGROUND

A number of microfabrication techniques have been used to form various microstructures. These techniques include photolithography, soft lithography, and micromolding, and have generally used photopolymerizable and temperature-dependent hydrogel precursor materials. However, rapidly-curing precursor materials, such as those cured using chemical and pH-crosslinking, have generally not been used due to difficulties associated with the very rapid curing of these materials, which generally occurs immediately upon contact with a curing or gelling agent.

Microparticles are another type of microstructure. Commonly used techniques for forming microparticles include emulsification, microfluidics and shear-induced droplet formation. While the latter two methods overcome the problem of polydispersity in particle size associated with emulsification, microfluidic generated particles are generally limited to using photocrosslinkable materials and shear-induced droplets are generally limited to producing spherical particles. None of these techniques provide a method for producing monodisperse hydrogel microparticles of controlled shape and size.

### SUMMARY

A controlled release process allows for a simple and cost-effective method of generating microstructures. The process uses a controlled release strategy for exposing the curing agent to the precursor material. The techniques may be applied to a wide range of precursor materials that cure or gel using a curing agent. This process also overcomes the limitations of existing methods regarding rapid-curing or rapid-crosslinking materials, including chemical and pH crosslinkable materials.

As used herein, the term “micro” generally encompasses both micro and nano. For example, as used herein, the term microscale includes the term nanoscale, the term microfabrication includes the term nanofabrication, and the term micropatterning includes the term nanopatterning.

As used herein, a “mechanically stable structure” refers to a structure that can be easily handled and released from the mold in which it was formed or patterned. Typically, the structure will be a microstructure.

As using herein, the term “curing agent” includes curing agents, crosslinking agents, gelling agents, etc. In a similar fashion, the term “cured” includes cured, crosslinked, gelled, fixed, and in general refers to the formation of a mechanically stable structure.

In one embodiment, a process includes shaping a precursor material into a desired configuration with a mold, supplying a curing agent from the mold to the precursor material, curing the precursor material to form a mechanically stable structure, and releasing the mechanically stable structure from the mold.

The process may also include applying a precursor material to a substrate, applying a precursor material to a secondary mold, or subjecting the precursor material applied to a secondary mold to vacuum. The process may also include supplying a curing agent to the mold.

The process may also include shaping a second precursor material into a second desired configuration with a second mold on top of the mechanically stable structure, supplying a second curing agent from the second mold to the second precursor material to cure the second precursor material to form a mechanically stable multilayer structure, and releasing the mechanically stable multilayer structure from the mold.

Supplying a curing agent may include diffusing a curing agent from the mold to the precursor material.

The mechanically stable structure may be a microstructure. The microstructure may be a micropatterned membrane, or may be a microparticle, or may be a microgel.

The precursor material may include an additional component, such as a drug, protein, or cell. The precursor material may be a hydrogel precursor material. Variously, the precursor material may be cured by chemically induced crosslinking, or pH-induced crosslinking. The mold may be formed of a hydrogel material, such as agarose.

In another embodiment, a process of encapsulating an additional component in a hydrogel includes shaping a hydrogel precursor material including an additional component into a desired configuration with a mold, supplying a curing agent to the hydrogel precursor material to form a mechanically stable hydrogel structure encapsulating the additional component, and releasing the mechanically stable hydrogel structure from the mold.

Variously the hydrogel may be an alginate hydrogel, chitosan hydrogel, fibronectin hydrogel, or a fibrin hydrogel. Variously, the additional component may be a cell, drug, or protein. Variously, the curing agent may be a calcium ion, or a pH-modifying agent. The hydrogel precursor material may form a mechanically stable hydrogel structure by crosslinking.

In another embodiment, a process for producing microparticles includes applying a precursor material to a secondary mold, shaping a precursor material into a desired configuration using a mold and the secondary mold, supplying a curing agent from the mold to the precursor material to cure the precursor material to form one or more mechanically stable microparticles, and releasing the one or more mechanically stable microparticles from the mold and secondary mold.

The process may include subjecting the precursor material applied to a secondary mold to change in environmental conditions, such as a vacuum.

The precursor material may include an additional component, and wherein the one or more mechanically stable microparticles encapsulate the additional component. The additional component may be a cell, stem cell, protein, drug, biomaterial, inorganic material, other component, or combinations thereof.

In another embodiment, a process for producing a membrane includes applying a precursor material to a substrate, shaping a precursor material into a desired configuration using a mold and the substrate, supplying a curing agent from the mold to the precursor material to cure the precursor material to form a mechanically stable membrane, and releasing the mechanically stable membrane from the mold.

The process may also include separating the membrane from the substrate. The membrane may be a micropatterned membrane. The precursor material may also include an additional component, and the mechanically stable membrane may encapsulate the additional component.

In another embodiment, a process includes providing a precursor material that has been shaped into a desired configuration with a mold, and supplying an agent from the mold to the precursor material to form a mechanically stable structure from the precursor material. The process may also include releasing the mechanically stable structure from the mold. The mold may be formed of a hydrogel, such as agarose, or poly(ethylene glycol). The mechanically stable structure may include a hydrogel, such as alginate, chitosan, or gelatin.

In another embodiment, a mold is described for shaping a precursor material to form a desired configuration, wherein the mold allows a curing agent to diffuse from the mold to the precursor material. The mold may be formed of a hydrogel, such as agarose or poly(vinyl alcohol).

In another embodiment, a mold is described for shaping a precursor material to form a desired configuration, wherein the mold comprises a hydrogel.

In another embodiment, a process for controlling the characteristics of monodisperse hydrogel microparticles includes shaping a precursor material into a desired configuration with a mold, supplying an agent from the mold to the precursor material to form mechanically stable microparticles from the precursor material, and releasing the microparticles from the mold.

The desired configuration may include a selected shape and size.

The microparticle may include a hydrogel. The microparticle may also include an encapsulated cell, stem cell, protein, drug, biomaterial, inorganic material, other component, or combinations thereof.

In another embodiment, a hydrogel microstructure is described that has been produced by a process that includes providing a precursor material shaped into a desired configuration with a mold, and supplying a curing agent from the mold to the precursor material to form a hydrogel microstructure having a mechanically stable structure.

The hydrogel microstructure may include microparticles, or a micropatterned membrane.

In another embodiment, a population of monodisperse, non-spherical microparticles is described, wherein the microparticles are formed from a hydrogel. Variously, the microparticles may be formed from a chemically-crosslinked hydrogel, or from a pH-crosslinked hydrogel.

In another embodiment, a hydrogel microstructure including a crosslinked hydrogel is described. Variously, the microstructure may be a microparticle, or may be a micropatterned membrane.

In another embodiment, a hydrogel microparticle encapsulating an additional material is described, wherein the microparticle has a area to volume ratio greater than a sphere. The area to volume ratio may also be at least 50% greater than a sphere. Variously, the microparticle may encapsulate a drug, cell, or protein.

The details of one or more embodiments are set forth in the accompanying drawings and the description below. Other features, objects, and advantages will be apparent from the description, drawings, and from the claims.

### DESCRIPTION OF DRAWINGS

FIG. 1 is a schematic of molding techniques using a controlled release process.

FIG. 2 is a number of images of patterned membranes and microparticles produced using a controlled release process.

FIG. 3 is a series of images showing a composite hydrogel and a hydrogel particle formed using a controlled release process.

FIG. 4 is a series of images showing microparticles enclosing cell and a co-culture array of cells in a pattern produced using a controlled release process.

FIG. 5 is a graph showing the time required for gelation of an alginate hydrogel using a controlled release process under various conditions.

FIG. 6 is a graph showing the initial viability of encapsulated cells in an alginate hydrogel formed using a controlled release process.

FIG. 7 is two micrographs showing micropatterned membranes after 1 day and 14 days.

### DETAILED DESCRIPTION

Methods and materials for practicing a controlled release microfabrication process are described. The controlled release microfabrication process can be used to form and fabricate microfabrication articles including micropatterns, micro-constructs, microgels, micro-fluidic devices, and microparticles. The described techniques provide control over the features and characteristics of the resulting microfabricated articles. The approach is especially suitable for materials that utilize a curing agent in the curing of the material.

The controlled release microfabrication process uses a precursor material and a curing agent. The precursor material is shaped into a desired configuration using a mold, and optionally a secondary mold and/or substrate.

The microfabrication articles are formed from at least one precursor material.

The precursor material may have various consistencies and states. The precursor material will generally be unformed, and unable to remain in a mechanically stable form. Most commonly, the precursor material will be in a liquid state. However, the precursor material may also be in other states, such as a viscous liquid, paste, semi-liquid, or other compositional state that can be formed by a mold.

The precursor material may include various compounds and chemicals. Typically, the precursor material will be biocompatible. Examples of compounds that may be present in a precursor material include alginate, chitosan, fibrinogen, PVA, hyaluronan, collagen, gelatin, fibrin precursors, and some self-assembling peptides. Alginate, chitosan, and fibrinogen are biocompatible materials that can form hydrogels and are materials that are commonly used in tissue engineering, drug delivery and cell culture applications. Generally, the precursor material is a material that is cured or “gels” through the application of a curing agent to the precursor material. In one embodiment, the precursor material may be cured by crosslinking. In one embodiment, the precursor material may be cured by chemical crosslinking, such as ionically crosslinking. In one embodiment, the precursor material may be cured by pH-dependent crosslinking. Examples of chemically crosslinkable materials include PVA/chitosan, hyaluronan, collagen, and gelatin.

In one embodiment, the precursor material may be a hydrogel precursor. Hydrogels are desirable because they can be tailored to produce desirable mechanical and chemical properties that resemble the native extracellular matrix. Hydrogels also generally exhibit high permeability to oxygen, nutrients, and other water-soluble metabolites. Accordingly, hydrogels have been widely used in biomedical applications such as tissue engineering and drug delivery. A hydrogel may be formed of a component dissolved or dispersed in an aqueous medium. The component concentration in the aqueous medium forming a hydrogel may vary depending upon the component used and the desired properties of the resulting microfabrication article. Typical concentrations may be provided as general guidelines. The concentration of the component in the aqueous medium to form a hydrogel may be 0.1% w/v or greater (e.g., 0.2% w/v or greater, 0.5% w/v or greater, 1.0% w/v or greater, 1.5% w/v or greater, 2.0% w/v or greater, 3.0% w/v or greater, 4.0% w/v or greater, or 5.0% w/v or greater). Typically the concentration of the component in the aqueous medium to form a hydrogel will be low enough to form a hydrogel and not create a separate phase or solid precipitate. The concentration of the component in the aqueous medium forming a hydrogel will typically have a concentration of 10% w/v or less (e.g., 9% w/v or less, 8% w/v or less, or 7% w/v or less).

Optionally, additional components may be combined into the precursor material. In various embodiments, one or more cells, stem cells, proteins, drugs, biomaterials, inorganic materials, and other components, or combinations thereof, may be combined into the precursor material. After curing the precursor material, these components may be suspended or encapsulated in the microfabrication article.

The precursor material is shaped into a desired configuration using a mold. The desired configuration can include a wide variety of shapes, sizes, dimensions, patterns, etc. In one embodiment, the mold may be used to form microfabrication articles such as micropatterns, microarrays, microstructures, micro-constructs, and microfluidic structures. In one embodiment, the mold may be used to form microparticles.

The curing agent (described below) may be supplied from the mold to the precursor material. The mold may be formed of a material that allows passage or diffusion of the curing agent to the precursor material. In some embodiments, the mold may be a hydrophilic material. In some embodiments, the mold may be formed of a hydrogel material. Examples of hydrogel materials that may be used as a mold material include agarose, poly(acrylamide), poly(ethylene glycol), poly(vinyl alcohol), and poly(HEMA). In some embodiments, the mold may be formed from a material in the form of semi-rigid or rigid foam.

Optionally, a substrate may be used together with the mold to form the precursor material into the desired configuration. Examples of suitable substrate materials include silicon, glass, and other non-permeable materials. In various embodiments, the substrate may be flat or may be shaped or patterned in some way.

Optionally, a secondary mold may be used together with the mold to form the precursor material into the desired configuration. In some embodiments, the secondary mold may be a hydrophilic material. In some embodiments, the secondary mold may be formed from elastomeric materials, such as Poly(dimethylsiloxane) (“PDMS”). Optionally, the material used to form the secondary mold may be treated to enhance or modify the surface properties of the material. For example, in one embodiment, a secondary mold may be formed using PDMS and plasma-treated to make the surface of the secondary mold material more hydrophilic. In embodiments using a secondary mold, the secondary mold may also be placed on a substrate material. This may be done, for example, to improve the ease of handling during processing.

The microfabrication process utilizes a curing agent to form a microfabrication article from the precursor material that has been shaped using the mold. Generally, the curing agent may interact with the precursor material in some fashion to cause a reaction or change in the precursor material. The curing process changes the precursor material in such a way that the cured precursor material retains the desired size or shape after removal from the mold and has a mechanically stable structure. In one embodiment, the precursor material may be crosslinked to form a mechanically stable structure. In one embodiment, the precursor material may form a hydrogel having a mechanically stable structure.

The curing agent that is used may be in different forms and compositions. Variously, the curing agent may be a liquid composition, a chemical, a compound, or a particle that causes the desired change in the precursor material. In one embodiment, the curing agent may be crosslinking agent. Examples of suitable crosslinking agents that may be used include calcium chloride, barium chloride, and glutaraldehyde. In one embodiment, the curing agent may be a composition that effectuates a change in the pH of the precursor material, causing a reaction or change in the precursor material. Examples of suitable compositions that effectuate a pH change include sodium hydroxide, potassium hydroxide, hydrochloric acid, and other strong and weak acids and bases.

The addition of a curing agent to the precursor material causes a reaction or change in the precursor material to produce a formed material. In various embodiments, the formed material may be a hydrogel. Examples of hydrogels that may be formed include alginate, chitosan, fibrin, fibronectin, and other hydrogels. Generally, the formed material may be any material produced by curing a precursor material by the addition of a curing agent.

Process

Controlled release processes utilize a mold to produce desired microfabrication articles from precursor materials. In general, the controlled release process may include supplying a precursor material, shaping the precursor material with a mold, curing the precursor material to form a microfabrication article in the desired shape and size, and releasing the microfabrication article from the mold. In one embodiment, the use of a mold in a controlled release process may be described as a soft lithographic process. A soft lithographic process is advantageous as it easy to implement and is scalable, can be used for the fabrication of microparticles and micropatterned membranes, and therefore offers excellent potential to be used for mass scale production.

A precursor material is selected for use in the process. After selection, the precursor material can be prepared for fabrication.

In one embodiment, the precursor material may be prepared for fabrication by placing the precursor material onto a substrate. For example, a substrate may be used together with a mold to form a micropatterned membrane, microarray, or micro-construct. In another embodiment, the precursor material may be prepared for fabrication by placing the precursor material into or over a secondary mold. For example, a secondary mold may be used together with a mold to form microparticles.

After preparing the precursor material for fabrication, the precursor material may be treated in some fashion, such as subjecting the precursor material to different environmental conditions. For example, a precursor material may be subjected to heat, cold, vacuum, a non-oxygen atmosphere, or other conditions in order to affect the precursor material. In one embodiment, a thin layer of precursor material may be coated over a secondary mold, and then the layer and secondary mold subjected to vacuum, degassing the precursor material layer. In addition, excess precursor material may be removed after preparing the precursor material or after treating the precursor material. For example, excess material can be scraped away from a secondary mold following de-gassing of the precursor material.

Optionally, a coating or material layer may be applied to the substrate or secondary mold. In some embodiments, a coating or other layer may be applied to a mold or secondary mold to facilitate separation of the mold from the secondary mold. In some embodiments, a coating or other layer may be applied to a substrate or secondary mold to facilitate separation of the formed microfabricated article.

After the precursor material has been prepared for fabrication, and following the optional treatment, a mold is brought into contact with the precursor material. In some embodiments, the mold may also contact portions of the secondary mold or substrate. In various embodiments, the mold may include a micropattern for impression into the precursor material. In other embodiments, the mold may include various depressions for forming microparticles having a desired size and shape.

The precursor material is pressed into a desired configuration through the use of various combinations of a mold, secondary mold, and substrate. In some embodiments, the treatment of the precursor material may be done to improve the ability of the precursor material to attain and/or retain the desired configuration. In some circumstances, contacting the mold and secondary mold together without proper preparation may lead to the formation of a continuous film with the mold and secondary mold. The proper preparation may include the use of a coating or other layer on the secondary mold, or a treatment of the precursor material.

In order to produce the desired microfabrication articles, the precursor material must be modified to form a mechanically stable structure. The various combinations of the mold, secondary mold, and substrate hold the precursor material in the desired configuration until a mechanically stable structure is formed. Formation of a mechanically stable structure may be accomplished by the addition of a curing agent to the precursor material. In various embodiments, the mechanically stable structure may be formed by polymerization of the precursor material, by gelling of the precursor material, by formation of a stable hydrogel, or by other processes. Thus, the mold, secondary mold, and substrate can provide a physical barrier while curing progresses. In addition to being a physical barrier and molding the precursor material, the mold also is simultaneously used in a manner to induce the curing of the precursor material.

The mold induces the curing of the precursor material by transmission of a curing agent. The curing agent may be supplied from or through the mold to the precursor material. Generally, the curing agent may be supplied over a period of time from the mold to the precursor material. In various embodiments, the curing agent may diffuse through the mold to the precursor material. The rate of diffusion may be affected by various factors including the type of mold material used, the type of curing agent used, the type of precursor material used, and the concentration of any of those materials and agents, as well as other factors. In one embodiment, the mold includes the curing agent when it is used to mold the precursor material. In one embodiment, the curing agent is supplied to the mold after the precursor material has been molded. In one embodiment, the mold includes the curing agent prior to molding and additional or a different curing agent is supplied to the mold after contacting the precursor material. Therefore, in various embodiments, the curing agent may diffuse through the mold at the same time as the precursor material is being molded, after the mold has been pressed into the desired configuration by the mold, or in some combination thereof.

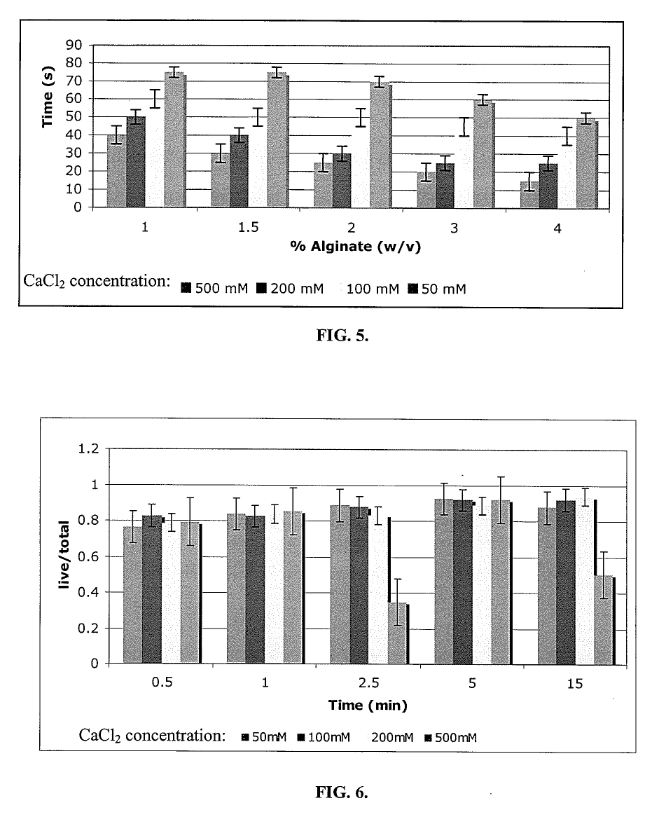

After sufficient time, the precursor material will be cured or fixed though the use of the curing agent to form the desired microfabrication article having a mechanically stable structure. The length of time required to produce a mechanically stable structure may depend on various factors including the curing process, the concentration of curing agent, the rate of diffusion of the curing agent, the concentration of various components in the precursor material, and other factors. The curing of the precursor material held in the desired configuration results in the formation of microfabrication articles having a controlled morphology. Examples of the length of time required to form a microstructure using various component concentrations are shown in FIG. 5 (described in Example 1). Typically, a chemical or pH crosslinking reaction may require less than 120 seconds, less than 100 seconds, or less than 90 seconds to form a cured microfabrication article having a mechanically stable structure. The time, however, may vary depending on a number of factors, including those discussed above.

After the mechanically stable structure has been formed, the microfabrication articles may be separated from the mold, secondary mold, and/or substrate used to form the microfabrication article. In some embodiments, the microfabrication articles may be readily separable. In some embodiments, additional removal steps may be used to assist the separation of the microfabrication articles from the mold, secondary mold, or substrate. Examples of steps that may be used include liquid washing, liquid spraying, gas spraying, application of vacuum, or applying physical or mechanical separation techniques. In some embodiments, the microfabrication article may not be entirely separated. For example, a micropatterned membrane may remain attached to a substrate for ease in later handling and/or experimentation.

Other approaches may also be used. In one embodiment, a precursor material is formed into a desired configuration using more than one mold. This approach allows for performing bidirectional molding, or even multidirectional molding on the precursor materials. In another embodiment, a first precursor material is formed and cured into a desired microstructure, and then a second precursor material and mold is used to form and cure a second layer, or parts of a second layer, on top of the first cured material. Other embodiments and approaches may also be used.

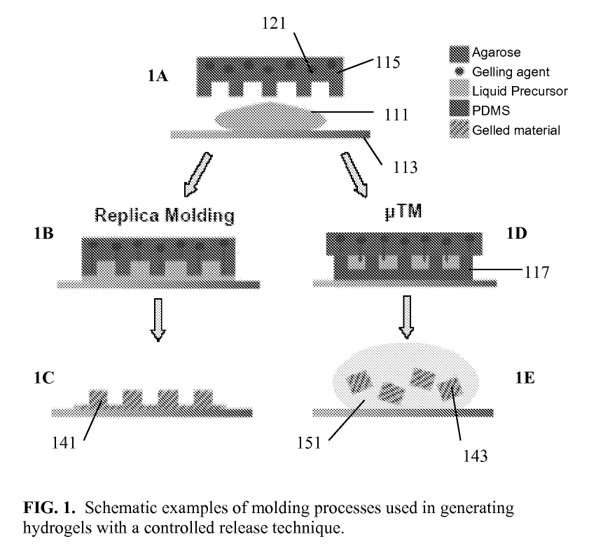

FIG. 1 is a schematic of molding techniques using a controlled release process. Two examples of embodiments of a controlled release process are illustrated in FIG. 1.

FIG. 1A shows a precursor material 111 that has been prepared for use by placing the precursor material 111 onto a substrate 113. The mold 115 is shown loaded with gelling/curing agent 121. FIG. 1B shows the mold 115 brought into conformal contact with the precursor material on the substrate 113. The curing agent 121 is also shown diffusing through the mold 115 and into the precursor material 111 that has been shaped into the desired configuration. After a sufficient time, the precursor material is formed into the microfabrication article and the mold 115 is separated from the microfabrication article, as shown in FIG. 1C. The microfabrication article shown is a micropatterned membrane 141, and the membrane 141 is shown remaining in contact with the substrate 113.

Thus, the sequence of FIGS. 1A, 1B, and 1C illustrates a patterned membrane produced using a replica molding process including sandwiching the precursor material between a flat or patterned substrate and the mold.

FIG. 1D illustrates another controlled release process that may be used. This figure shows a precursor material prepared for use by applying the precursor material to a secondary mold 117 on a substrate 113 as in FIG. 1A. The mold 115 containing the curing agent 121 is brought into conformal contact with the precursor material 117, and in places with the secondary mold 117. The curing agent 121 diffuses through the mold 115 and into the precursor material 111 that has been shaped into the desired configuration. After a sufficient time, the precursor material is formed into a microfabrication article of the desired size and shape. The microfabrication article in FIG. 1E is a number of microparticles 143. The microparticles 143 have been separated from the mold 115, secondary mold 117, and substrate 143, and are shown dispersed in a liquid 151.

Thus, the sequence of FIGS. 1A, 1D, and 1E illustrates the production of microparticles using microtransfer molding (μTM). This molding approach includes forming desired microparticles between a mold and a secondary mold.

The two figure series in FIG. 1 are schematic examples of molding processes used in generating hydrogels with a controlled release technique.

Products

Microfabricated articles of various sizes, shapes, and characteristics may be formed using the controlled release process. Examples of microfabricated articles that may be produced include micropatterned membranes, micro-constructs, microgels, micro-fluidic devices, and microparticles.

Microfabricated articles may be produced that include a wide range of features, sizes, dimensions, and shapes. Effectively, the features produced may be any that can be molded. The dimensions of articles and features produced may range from 1 μm or less to sizes easily visible with the naked eye. For example, micropatterned membranes may be produced that include features with lateral dimensions from less than 1 μm in size. Generally, the lateral dimension may be at least 5 μm or greater. The lateral dimension may be up to the size of the membrane. Generally, the lateral dimension may be 2000 μm or less. Similarly, the vertical dimension of a micropatterned membrane may be less than 1 μm in size. Generally, the vertical dimension will be 5 μm or greater, or 10 μm or greater. Generally, the vertical dimension will be 1000 μm or less, 500 μm or less, 300 μm or less, or 200 μm or less. In addition, microparticles of various dimensions may also be produced. Microfabrication articles may be produced that have various shapes, sizes, and designs. For example, microparticles may be produced that are fully symmetrical (e.g. spherical, cubic) and asymmetrical (e.g. rectangular rhomboid, pyramidal) shapes. As another example, micropatterns may be produced that are regular or irregular, or which have small or large spacing between molded areas in the pattern. The ability to produce microparticles of various shapes means that microparticles may be produced having different area to volume ratios than the area to volume ratio of a sphere. In one embodiment, a microparticle may be produced having an area to volume ratio less than that of a sphere. In other embodiments, a microparticle may be produced having an area to volume ratio at least 25% less than that of a sphere, or at least 50% less than that of a sphere. In one embodiment, a microparticle may be produced having an area to volume ratio greater than that of a sphere. In other embodiments, a microparticle may be produced having an area to volume ratio at least 25% greater than that of a sphere, or at least 50% greater than that of a sphere.

The controlled release process for producing microparticles enables articles to be produced that have controlled and consistent size and shape. As the same mold may be used repeatedly, the process is able to produce microfabrication articles having a high degree of reproducibility. In various embodiments, microfabrication articles may be produced that have a size variation of 10% or less, or 5% or less. For example, microparticles may be produced that are spherical, cubic, or of other geometric shapes. In one embodiment, a population of monodisperse microparticles can be produced. A monodisperse population is a population of microparticles of very similar size and shape. For example, a monodisperse population may be composed of microparticles wherein 95% of the particles have a standard deviation of volume of 33%, 25%, 20%, or 10%, or 5% or less. A polydisperse population is a population having a wide range of particle sizes, which typically follows a normal distribution curve, wherein a significant fraction of particles (e.g., >5%) may be 2 times, 3 times, 5 times, or even 10 times larger than a second significant fraction (e.g. >5%). In another embodiment, the dispersion of particle sizes can be controlled. For example, a population of microparticles of two different sizes may be desired. A bi-modal distribution of particles may be produced by combining two monodisperse populations, or may be produced by using a mold to simultaneously form microparticles having the two desired sizes. In other embodiments, other combinations of particle sizes may be produced.

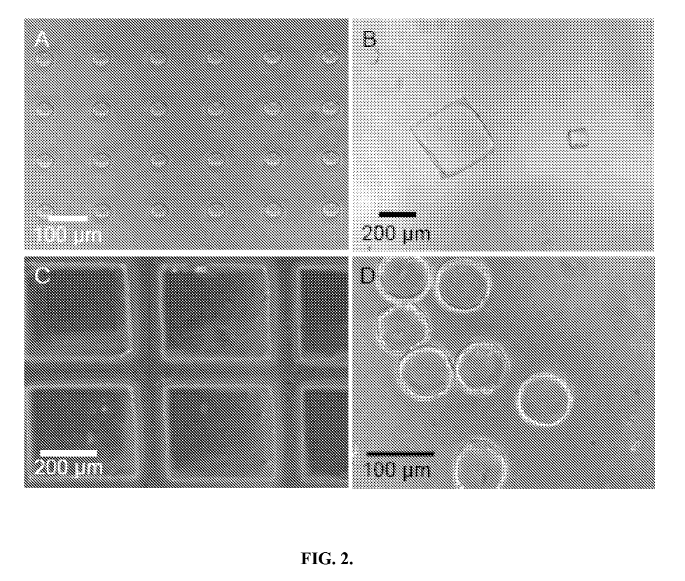

FIG. 2 is a number of images of patterned membranes and microparticles produced using a controlled release process. Examples of microfabricated articles produced using different controlled release methods are shown in FIG. 2, as FIGS. 2A and 2C show micropatterned membranes, while FIGS. 2B and 2D show microparticles

The micropatterned membrane shown in FIG. 2A was generated from alginate hydrogel precursor materials. An alginate hydrogel precursor material was held in a desired configuration using a silicon substrate and an agarose mold. The precursor material was subsequently gelled by the controlled release of calcium ions from the agarose mold. This formed the alginate hydrogel micropatterned membrane of FIG. 2A. In a similar fashion, an alginate hydrogel precursor material was held in a desired configuration using a plasma cleaned PDMS secondary mold and an agarose mold. The precursor material was subsequently gelled by the controlled release of calcium ions from the agarose mold. This process formed the cubic alginate hydrogel microparticles of FIG. 2B.

The micropatterned membrane shown in FIG. 2C was produced by molding a chitosan hydrogel precursor material between a silicon substrate and an agarose mold containing a basic pH compound. The chitosan precursor material normally has a pH of about 6, and may be cured by pH catalysis. The precursor material was subsequently gelled by the controlled release of basic components from the agarose mold, which had been prepared by hydrating a dried agarose mold in a 5% w/v NaOH. This formed the chitosan hydrogel micropatterned membrane of FIG. 2C. In a similar fashion, a chitosan hydrogel precursor material was held in a desired configuration using a plasma cleaned PDMS secondary mold and an agarose mold. The agarose mold was prepared by hydrating in a NaOH solution as described above, and the precursor material was subsequently gelled by the controlled release of basic components from the agarose mold. This process formed the spherical chitosan hydrogel microparticles of FIG. 2D.

FIG. 2 also illustrates that a wide variety of microfabricated articles may be formed using a controlled release process. In various embodiments, the microfabricated articles may have different patterns, different shapes, different sizes, and may be formed of different materials. For example, the micropattern of FIG. 2C has elements of a larger size which are closer together that the elements of the micropattern of FIG. 2A, demonstrating some of the variety of feature attributes that can be formed.

Furthermore, FIG. 2C also illustrates that the process may be used to produce multilayered microfabrication articles by sequential molding. In the embodiment shown in FIG. 2C, a multilayered hydrogel construct was produced using sequential molding of hydrogel precursor materials.

In various embodiments, additional components may be encapsulated in the microfabricated articles. This encapsulation forms a composite article. In various embodiments, cells, stem cells, proteins, drugs, biomaterials, inorganic materials, and other components may be located within or on the surface of the microfabricated articles. For example, microfabricated articles may be formed using microscale hydrogels, which can be used to encapsulate and deliver drugs in a sustained manner. In addition, the ability to tailor the size and shape of the microfabricated articles in combination with the other components added can be beneficial. For example, the size and shape of microparticles may be controlled and used to tailor drug release kinetics for drug delivery applications. As another example, the microfabrication can be controlled to assemble micro-constructs for tissue engineering.

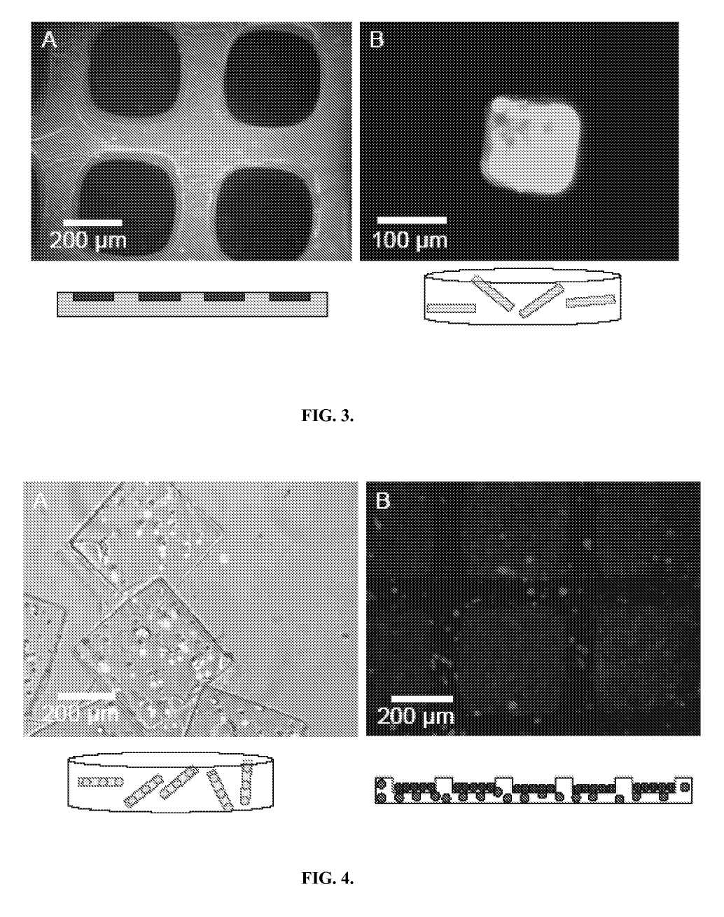

FIG. 3 is a series of images showing a composite hydrogel and a hydrogel particle formed using a controlled release process, and illustrates microfabricated articles that include additional components. The micro-construct of FIG. 3A was produced by sequential molding of alginate hydrogels. Alginate precursor materials containing FITC-BSA or rhodamine were molded on each other by first fabricating a thin patterned layer of alginate hydrogel containing FITC-BSA (green), and subsequently filling the rectangular void regions of the pattern with a second fabricated alginate hydrogel containing rhodamine (red). 3D constructs, like that in FIG. 3A, may be used to study cell behavior and migration. A similar approach and method may be used for fabricating constructs with more complex architectures for tissue engineering applications.

FIG. 3B is a photograph of a microparticle that includes FITC-BSA as an additional component. The microparticle was produced by molding and curing alginate hydrogel precursor materials containing a fluorescently green labeled model protein (FITC-BSA) into a cubic shape having a certain size. The ability to engineer the size, shape, and network density of hydrogel microparticles may be used to control the release kinetics of encapsulated components such as molecules, proteins, drugs, etc.

FIG. 4 is a series of images showing microparticles enclosing cell and a co-culture array of cells in a pattern produced using a controlled release process. FIG. 4 further illustrates the applicability of the controlled release process to tissue engineering, through the formation of microfabrication articles that include cells. In one approach, shown in FIG. 4A, cells were encapsulated in rectangular hexahedron microparticles formed using alginate precursor materials containing NIH-3T3 cells. The cells were stained to show live (green) and dead (red) cells to measure and demonstrate cell viability. A wide range of cell densities may be used to generate microstructures with high cell viability (e.g., >80% living cells).

In another approach, shown in FIG. 4B, a microstructure was produced using alginate precursor materials containing PKH26 cells. The microstructure, a micropatterned membrane, was formed from alginate hydrogels embedded with PKH26 stained AML 12 hepatocytes (red). Then, stained mouse embryonic stem cells (Cell-Tracker Blue) were seeded within the formed microwells. This demonstrated the ability to create and control heterotypic cell-cell interactions in a 3D environment using natural hydrogels. This demonstrates that cell-laden micromolded hydrogels may be used in the study of cell-cell interactions in vitro, as the micro-construct can be used to mimic the native tissue complexity and architecture.

Uses

Microfabricated articles formed using a controlled release process can be used for a variety of applications. These applications include use in scalable cell culture systems, diagnostics, drug delivery, and tissue engineering. In one embodiment, tissue engineering structures may be formed and assembled from smaller cell-laden structures comprised of chemical or pH-crosslinkable hydrogels. In one embodiment, shape-controlled microparticles may be formed and serve as drug delivery vehicles composed of previously incompatible materials. In another embodiment, micropatterned membranes may be designed and formed to serve as cell arrays for biologists involved in basic biological research. In another embodiment, a micropattern including cells may be used for the study of the stem cell differentiation.

The simple and robust microfabrication approach using a controlled release process has a wide range of uses. Some of the areas for application of this approach include:
Tissue Engineering

Complex 3D tissue structures may be desirable as the spatial orientation of heterotypic cells may influence both tissue function and development. Microscale hydrogels of controlled shapes may be used in an approach to tissue engineering in which smaller cell-laden structures are assembled into larger macroscale 3D structures. In contrast to traditional seeding-and-remodeling methods, this approach can directly place different cell types into the necessary spatial orientations. The controlled release process provides a method of obtaining precise control over the features of the microfabricated articles. The controlled release process also enables the use of material that is cured using a curing agent, such as chemical and pH-controlled crosslinking.
Drug Delivery

Traditional drug-delivery particle shapes have generally been limited to spherical shapes, resulting in a restricted range of drug release kinetics, as the surface-area-to-volume ratio of particles scales with the diameter of the sphere. Therefore, the production of drug delivery particles in shapes with different surface area-to-volume ratios than traditional shapes may allow superior control over drug release rates. In addition, the controlled release process also enables the use of hydrogel materials such as calcium alginate to be micromolded into free particles of controlled shapes. The ability to engineer the size, shape and network density of the hydrogel particles can be used to control the release kinetics of the encapsulated molecules.
Cell Encapsulation

The controlled release process is also amenable for cell encapsulation applications. For example, it may used to generate co-cultures in which one cell type is encased within the matrix of the material while another cell type may be localized within defined regions such as microwells. Such an approach may be interfaced with high-throughput methods using traditional microarray technologies or microfluidics.
Immunoisolation Cell-Based Therapy
Bioprocess Applications
Combinatorial library screening
Diagnostics
Manufacturing cell, protein, and DNA arrays
Stem cells and basic biological research
Scalable cell culture systems

### Materials and Methods

Materials

All tissue culture media and serum were purchased from Gibco Invitrogen Corporation unless otherwise noted.

All cell lines were purchased from American Type Culture Collection unless otherwise noted.

All chemicals were purchased from Sigma unless otherwise indicated.

Poly(dimethylsiloxane) (“PDMS”) was purchased from Sylgard, Dow Corning.

Collagen Type-1 Rat Tail (BD Biosciences) 500 μg/ml, FN 5 μg/ml, and HA from rooster comb 5 mg/ml were prepared by diluting in distilled water.

Cell Cultures

All cells were manipulated under sterile tissue culture hoods and maintained in a 95% air/5% CO₂ humidified incubator at 37° C.

NIH-3T3 mouse embryonic fibroblast cells were maintained in Dulbecco's modified Eagle media (DMEM) supplemented with 10% FBS. Confluent dishes of NIH-3T3 cells were passaged and fed every 3-4 days.

Murine embryonic stem (mES) cells (R1 strain) were maintained on gelatin treated dishes with media comprised of 15% ES qualified FBS in DMEM knockout medium. ES cells were fed daily and passaged every 3 days at a subculture ratio of 1:4.

AML12 murine hepatocytes were maintained in a medium comprised 90% of 1:1 (v/v) mixture of DMEM and Ham's F12 medium with 10% FBS. Confluent dishes of AML12 cells were passaged and fed every 3-4 days.

Precursor Materials

Alginate hydrogel precursor was prepared by dissolving alginic acid (Sigma) in cell-culture media prepared as described above (for use with either mES, NIH-3T3, or AML12 cells), or in double distilled (“dd”) H₂O to obtain the desired final concentration (1% w/v, 1.5% w/v, 2% w/v, 3% w/v, 4% w/v) at 37° C.

For the preparation of fluorescently-labeled alginate hydrogels, rhodamine (Sigma) or fluorescein isothiocynate conjugated to bovine serum albumin (FITC-BSA, from Sigma) were dissolved in ddH₂O to obtain a concentration of 200 μg/ml prior to addition of the alginic acid.

Alginate is one example of a material that may be ionically-crosslinked to form a hydrogel using the controlled release process. Alginate has been extensively studied for a variety of biomedical applications. It is well characterized and can be modified to tailor its mechanical, chemical, and biological properties for drug delivery, cell-based therapy, and tissue engineering. It has already found widespread clinical use in cell-based therapy and drug delivery. There have also been significant difficulties with micromolding alginate using other approaches.

Chitosan hydrogel precursor was prepared by dissolving 2% w/v chitosan (practical grade from crab shells, Sigma) in a pH 5.7 solution of hydrochloric acid (Fisher Scientific) diluted in ddH₂O Chitosan is a linear 1,4-linked polysaccharide of glucosamine and N-acetylglucosamine that is obtained by the partial deacetylation of chitin. Chitosan is a naturally-derived nontoxic, biocompatible, and biodegradable polymer with anti-microbial and immunomodulating activity, and has been used in various bioengineering and clinical applications.

Chitosan is one example of a material that may be pH-crosslinked to form a hydrogel using the controlled release process. The sol-gel transition of chitosan is due to presence of the primary amine at the C-2 position of the glucosamine residues. At low pH, these amines are protonated and positively charged, and chitosan is a water-soluble cationic polyelectrolyte. At higher pH (above approximately 6.5), the chitosan amines become deprotonated and the polymer loses its charge and becomes insoluble. The formation of inter-polymer associations (e.g., liquid crystalline domains or network junctions) results in the formation of hydrogels. There have also been significant difficulties with micromolding chitosan using other approaches.

Mold Fabrication

Agarose molds were prepared by pouring molten agarose solution on positive and negative SU-8 patterned silicon masters, as well as on flat surfaces to create patterned and flat molds, respectively. Agarose solutions were generated by heating agarose (Aldrich) in ddH₂O until dissolved. Various agarose concentrations were tested, from 1.5% to 10% w/v. For some molds, CaCl₂ (Sigma) was added to the molten agarose to obtain a final concentration of 10 mM, 50 mM, 100 mM, 200 mM or 500 mM CaCl₂ in the agarose mold. These molds were prepared for use with alginate hydrogel precursor material. For some molds, the agarose mold was removed from the SU-8 master, allowed to dry at room temperature overnight, and then hydrated in a bath of 5% NaOH (Sigma) in ddH₂O for 5-6 hrs before use. These molds were prepared for use with chitosan hydrogel precursor material.

PDMS secondary molds including micropatterns of various shapes were fabricated by curing PDMS prepolymer (Sylgard 184, Essex Chemical) on silicon masters patterned with SU-8 photoresist. The patterns on the masters had protruding shapes (squares, circles, long rectangles) of various sizes (ranging from 20 to 400 μm) as well as features patterned in depth, so that secondary molds with wells and with protruding features could be produced. PDMS secondary molds were generated by pouring 1:10 curing agent to silicon elastomer onto the master and curing for 2 h at 70° C. Finally, the PDMS secondary molds were peeled from the silicon masters, and cut into small shapes. Before use, the secondary molds were rendered hydrophilic by plasma cleaning for 10 minutes on medium power (PDC-001, Harrick Scientific).

Cell Encapsulation

Variously, NIH-3T3, mES or AML12 cells were added as an additional component and suspended within the precursor material solution and used to form microfabrication articles having encapsulated cells. The cells used were first trypsinized with 0.23% trypsin and 0.13% EDTA in PBS (Gibco) and then centrifuged at 1000 rpm for 2 min to produce a cell pellet. The pellet was then resuspended in the precursor material solution.

Imaging and Analysis

Phase contrast and fluorescent images were taken on a Nikon TE2000 fluorescent microscope. Cell viability within the microstructures was assessed using Live/dead stain. The microstructures were stained with 200 μl PBS solution containing 2 μg/ml calcein AM and 4 μg/ml ethidium homodimer-1 (Molecular Probes) and visualized under FITC and TRITC filters. Two recognized parameters of cell viability—intracellular esterase activity and plasma membrane integrity—were tracked. Live cells fluoresced green, showing intracellular esterase activity that hydrolyzed the fluorogenic esterase substrate (calcein AM) to a green fluorescent product, and dead cells fluoresced red, their plasma membrane being compromised and therefore permeable to the high-affinity, red fluorescent nucleic acid stain (ethidium homodimer-1). Co-cultured cells were labeled using PKH26 (Sigma) and CellTracker Blue (Invitrogen, http://probes.invitrogen.com) dyes, processed according to the manufacturer specifications.

### EXAMPLES

### Example 1

### Polymerization Properties

FIG. 5 is a graph showing the time required for gelation of an alginate hydrogel using a controlled release process under various conditions. The graphs illustrate the effects of alginate concentration in the hydrogel precursor material, and also show the effects of calcium chloride concentration in the mold used to form the microstructures. The interactions of those concentrations on the polymerization properties of the resulting microstructure materials are graphically represented.

Various amounts of alginate and calcium chloride were used in multiple combinations to form microstructures. The time required to form mechanically stable microstructures using different combinations was measured. These measurements and combinations are reported in the graph of FIG. 5. Under all conditions tested, the time required for generating mechanically stable structures of either micropatterned membranes or microparticles was less than 90 seconds. This finding was consistent with the very high diffusivity of small ions in hydrogels. It was also consistent with the small characteristic dimensions of the different constructs molded, which were typically less than a couple hundred micrometers.

In general, the rate of diffusion of the gelling agent from the mold to the precursor material was controllable by varying the material concentration forming a mold material, or by varying the degree of crosslinking of the mold material. For example, preliminary experiments that varied the agarose concentration in the mold material between 1.5% and 10% showed some increase in the gelation time as the agarose concentration increased. This was likely due to progressively reduced average agarose pore size, which resulted in slower diffusion of the gelling agent from the mold.

The results shown in FIG. 5 also illustrate that increasing alginate concentration in the hydrogel precursor decreased the time to form mechanically stable structures. In addition, the result also illustrate that the curing agent concentration in the mold (Ca²⁺ concentration in the agarose mold) decreased the time to form mechanically stable structures.

### Example 2

### Cell Staining

To visualize various cell types in patterned co-cultures, cells were stained with fluorescently labeled dyes and tracked in culture. The colors were obtained using the following dyes:

Green carboxyfluorescein diacetate succinimidyl ester (“CFSE”).
Cells were stained with CFSE dye by suspending cells in 10 μg/mL CFSE in PBS solution at a concentration of 1×10⁷ cells/mL and incubated for 10 minutes at room temperature. The staining reaction was quenched by addition of an equal volume of DMEM supplemented with 10% FBS, centrifuged, and resuspended in fresh medium.

Red PKH26.
Cells were stained with PKH26 dye by suspending cells (2×10⁷ cells/mL) in a diluent-C solution and mixed with 4×10⁻⁶ M PKH26 dye in a 1 mL of diluent-C solution and incubated at 25° C. for 5 minutes. The staining reaction was quenched by addition of an equal volume of DMEM supplemented with 10% FBS, centrifuged, and resuspended in fresh medium.

Blue Cell Tracker Blue (Molecular Probes).
Cells were stained with Cell Tracker Blue by centrifuging cells and then resuspending the cells in a pre-warmed working solution having 5 μm dye in PBS and incubated for 15 to 30 minutes under growth conditions appropriate for the particular cell type.

### Example 3

### Cell Viability

A live/dead cell fluorescence assay was performed to assess the effects of the described microfabrication process on encapsulated cell viability. NIH-3T3 cells were suspended in 4% w/v alginate precursor solutions and molded into micropatterned membranes. The cells were thus encapsulated when the precursor material cured. The viability values were calculated as the percentage of live cells in the molded membrane structure. This percentage was obtained by counting the number of live (green) cells and the number of dead (red) cells in a representative 1500 μm×1000 μm rectangular area magnified at 4× and dividing the number of live cells by the number of total cells (live plus dead). Measurements were taken in quadruplicate, and error bars were based on standard deviation values for n=4. The results are shown in the graph of FIG. 6.

FIG. 6 is a graph showing the initial viability of encapsulated cells in an alginate hydrogel formed using a controlled release process. Various concentrations of the curing agent (calcium chloride) were used along with different molding times. The data indicates that initial cell viability remains high under this fabrication technique for most concentrations of CaCl₂ and molding times. These results are consistent with other cases reporting cell viability over several weeks of cell cultures embedded within alginate microspheres of sizes comparable to or larger than those fabricated using a controlled release process.

### Example 4

### Feature Retention

In general, the mechanical properties of the micropatterned hydrogels could be altered by varying the precursor concentration and gelling conditions. In all cases, features remained stable after long-term (>2 weeks) incubation in cell culture media at 37° C.

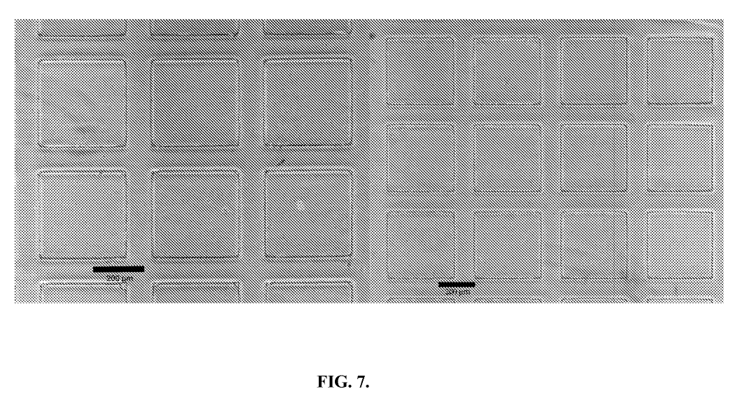

Various microfabrication articles were tested for feature retention after incubation in cell culture media at 37° C. Feature degradation appeared to be minimal in all cases. FIG. 7 shows two example micropatterned membranes.

FIG. 7 is two micrographs showing micropatterned membranes after 1 day and 14 days. The photos show micropatterned membranes having lateral feature dimensions of 350 μm. FIG. 7A shows a microstructure a few hours following fabrication, while FIG. 7B shows the same microstructure after 14 days of incubation.

### Example 5

### Replica Molding and Micro-Transfer Molding (μTM)

Replica molding was used to produce hydrogel micropatterned membranes. The hydrogel precursor was poured on top of a flat substrate, and an agarose mold containing the gelling agent was applied directly to the liquid hydrogel precursor.

Micro-Transfer Molding (μTM) was employed to obtain microgels and microfabricated particles. A thin layer of precursor material was coated over a PDMS mold. After briefly (˜30 s) degassing in a vacuum chamber (PDC-001, Harrick Scientific) and scraping away excess material, the agarose mold containing the gelling agent was pressed against the mold. This procedure was required to overcome the weak seal formed between PDMS and agarose, which otherwise led to the formation of a continuous film.

After gelling, the agarose mold was removed to retrieve the microgels. In this process, most microgels remained attached to the mold microwells. After hydrating the microgels upon the mold, a number of individual microgels spontaneously detached from the microwells. To remove any remaining microgels, a pipette tip was gently brushed over the surface the mold.

In summary, a controlled release fabrication method enables the production of articles formed from materials that are cured after being formed into a desired configuration. The controlled release fabrication method uses a controlled release strategy whereby a curing agent or gelling agent is released from within the mold into the precursor material during the molding process to produce patterned membranes and free particles of controlled sizes and shapes. This approach significantly extends micromolding approaches to a much larger class of materials, including chemical and pH dependant crosslinking hydrogels.

A number of embodiments of the invention have been described. Nevertheless, it will be understood that various modifications may be made without departing from the spirit and scope of the invention. For example, while the examples are focused on calcium alginate and chitosan hydrogels, the techniques present are generally applicable to any material that uses a curing agent. In particular, the techniques may be used by other chemically crosslinkable and pH dependent hydrogels. The techniques may also be used to form multilayer microfabrication articles, having even more complex patterns and cell interactions than those created using a single mold. In addition, other cells, proteins, or biological material may be used in similar manner as described. Furthermore, the techniques may be used to produce fabricated articles of a larger size. Accordingly, other embodiments are within the scope of the following claims.

What is claimed is:

1. A process, comprising:
shaping a precursor material into a desired configuration with a mold;
supplying a curing agent from the mold to the precursor material;
curing the precursor material to form a mechanically stable structure; and
releasing the mechanically stable structure from the mold.

2. The process of claim 1, further comprising applying a precursor material to a substrate.

3. The process of claim 1, further comprising:
shaping a second precursor material into a second desired configuration with a second mold on top of the mechanically stable structure;
supplying a second curing agent from the second mold to the second precursor material to cure the second precursor material to form a mechanically stable multilayer structure; and
releasing the mechanically stable multilayer structure from the mold.

4. The process of claim 1, wherein shaping a precursor material into a desired configuration with a mold comprises shaping a precursor material into a desired configuration using a primary mold form and a secondary mold form, and wherein releasing the mechanically stable structure from the mold comprises releasing the mechanically stable structure from a primary mold form and secondary mold form.

5. The process of claim 1, wherein supplying a curing agent comprises diffusing a curing agent from the mold to the precursor material.

6. The process of claim 1, wherein the mechanically stable structure comprises a microstructure.

7. The process of claim 6, wherein the microstructure comprises a micropatterned membrane, a microparticle, or a microgel.

8. The process of claim 1, wherein the precursor material further comprises an additional component.

9. The process of claim 7, wherein the additional component comprises a drug, protein, or cell.

10. The process of claim 1, wherein the precursor material is cured by chemically induced crosslinking or by pH-induced crosslinking.

11. The process of claim 1, wherein the mold comprises agarose.

12. A process of encapsulating an additional component in a hydrogel, comprising:
shaping a hydrogel precursor material including an additional component into a desired configuration with a mold;
supplying a curing agent to the hydrogel precursor material to form a mechanically stable hydrogel structure encapsulating the additional component; and
releasing the mechanically stable hydrogel structure from the mold.

13. The process of claim 11, wherein the hydrogel comprises alginate, chitosan, fibronectin, or fibrin.

14. The process of claim 11, wherein the additional component comprises a drug, protein, or cell.

15. The process of claim 11, wherein the curing agent comprises a calcium ion.

16. The process of claim 11, wherein the curing agent comprises a pH-modifying agent.

17. A hydrogel microparticle encapsulating an additional material, wherein the microparticle has an area to volume ratio greater than a sphere.

18. The microparticle of claim 17, wherein the microparticle has an area to volume ratio at least 50% greater than a sphere.

19. The microparticle of claim 17, wherein the microparticle encapsulates a drug, cell, or protein.

20. The microparticle of claim 17, wherein the microparticle encapsulates a cell, stem cell, protein, drug, biomaterial, inorganic material, other component, or combinations thereof.
